(19) United States
(12) Patent Application Publication
(10) Pub. No.: US 2015/0035864 A1
(43) Pub. Date: Feb. 5, 2015

(54) METHOD, APPARATUS, COMPUTER PROGRAM AND USER INTERFACE

(71) Applicant: NOKIA CORPORATION, Espoo (FI)

(72) Inventors: David Murphy, Helsinki (FI); Kate Freebairn, Helsinki (FI); Michiel Terlouw, Helsinki (FI); Thomas Moltoni, Helsinki (FI); John Evans, Helsinki (FI); Felice Mancino, Helsinki (FI)

(21) Appl. No.: 14/367,910

(22) PCT Filed: Dec. 18, 2012
(86) PCT No.: PCT/IB2012/057435

§ 371 Date: Jun. 21, 2014

(30) Foreign Application Priority Data
Dec. 22, 2011 (GB) 1122190.0

(51) Int. Cl. G09G 5/373; G06F 3/041; G06F 3/0488; G09G 5/377

(52) U.S. Cl. CPC G09G 5/373; G09G 5/377; G06F 3/0412; G06F 3/04883; G09G 2340/045; G09G 2340/12; G09G 2354/00
USPC 345/634; 345/661; 345/173

(57) ABSTRACT

A method, apparatus, computer program and user interface where the method comprises: using a first application to cause content associated with a location to be displayed on a display; detecting a user input; and in response to the user input, determining the scale of the content, and if the scale of the content is above a threshold accessing a second, different application to cause a graphical representation indicative of the location associated with the content to be displayed on the display and if the scale of the content is below a threshold continuing using the first application to change the scale of the content displayed on the display.

### TECHNOLOGICAL FIELD

Embodiments of the present disclosure relate to a method, apparatus, computer program and user interface. In particular, they relate to a method, apparatus, computer program and user interface which enable a user to view content on a display.

### BACKGROUND

Apparatus which enable a user to view content are well known. For example, mobile telephones, tablet computers and digital cameras and other types of electronic apparatus have displays which enable a user to view content. The content may be, for example, image or videos or websites or any other type of content.

The apparatus may have a plurality of different functions. For example, the apparatus may be configured to capture images and also enable access to communication networks such as the internet and cellular communications networks. This may enable the apparatus 1 to be used to access different items of content.

It may be beneficial to enable a user to associate different items of content and information together.

### BRIEF SUMMARY

According to various, but not necessarily all, embodiments of the disclosure there is provided a method comprising: using a first application to cause content associated with a location to be displayed on a display; detecting a user input; and in response to the user input, determining the scale of the content, and if the scale of the content is above a threshold accessing a second, different application to cause a graphical representation indicative of the location associated with the content to be displayed on the display and if the scale of the content is below a threshold continuing using the first application to change the scale of the content displayed on the display.

In some embodiments the content may be associated with a location by assigning metadata to the content where the metadata enables the location to be uniquely identified.

In some embodiments the location may comprise a real world location.

In some embodiments the content may be geotagged.

In some embodiments the content may comprise an image.

In some embodiments the content may comprise a video.

In some embodiments the graphical representation of the location may comprise a map.

In some embodiments the graphical representation of the location may replace the content on the display. In other embodiments the graphical representation of the location may be displayed with the content overlaying the portion of the graphical representation of the location corresponding to the location associated with the content

In some embodiments the method may further comprise, in response to the user input, determining a value of the user input and if the value of the user input is above a threshold accessing the second, different application and if the value of the user input is below a threshold continuing using the first application to change the scale of the content displayed on the display by an amount determined by the value of the user input. The user input may comprise deforming a housing of an apparatus and the value of the user input comprises the magnitude and direction of the deformation. The user input may comprise actuating a touch sensitive display by making a trace input and the value of the user input comprises the length and direction of the trace.

According to various, but not necessarily all, embodiments of the disclosure there is provided an apparatus comprising: at least one processor; and at least one memory including computer program code; wherein the at least one memory and the computer program code are configured to, with the at least one processor, enable the apparatus to: use a first application to cause content associated with a location to be displayed on a display; detect a user input; and in response to the user input, determine the scale of the content and if the scale of the content is above a threshold access a second, different application to cause a graphical representation indicative of the location associated with the content to be displayed on the display and if the scale of the content is below a threshold continue using the first application to change the scale of the content displayed on the display.

In some embodiments the content may be associated with a location by assigning metadata to the content where the metadata enables the location to be uniquely identified.

In some embodiments the location may comprise a real world location.

In some embodiments the content may be geotagged.

In some embodiments the content may comprise an image.

In some embodiments the content may comprise a video.

In some embodiments the graphical representation of the location may comprise a map.

In some embodiments the at least one memory and the computer program code may be configured to, with the at least one processor, enable the apparatus to replace the content on the display with the graphical representation of the location.

In some embodiments the at least one memory and the computer program code may be configured to, with the at least one processor, enable the apparatus to display the graphical representation of the location with the content overlaying the portion of the graphical representation of the location corresponding to the location associated with the content.

In some embodiments the at least one memory and the computer program code may be configured to, with the at least one processor, enable the apparatus to, in response to the user input, determine a value of the user input and if the value of the user input is above a threshold access the second, different application and if the value of the user input is below a threshold continue using the first application to change the scale of the content displayed on the display by an amount determined by the value of the user input.

In some embodiments the user input may comprise deforming a housing of an apparatus and the value of the user input comprises the magnitude and direction of the deformation.

In some embodiments the user input may comprise actuating a touch sensitive display by making a trace input and the magnitude of the user input comprises the length of the trace.

According to various, but not necessarily all, embodiments of the disclosure there is provided a computer program comprising computer program instructions that, when executed by at least one processor, enable an apparatus at least to perform: use a first application to cause content associated with a location to be displayed on a display; detect a user input; and in response to the user input, determine the scale of the content and if the scale of the content is above a threshold access a second, different application to cause a graphical representation indicative of the location associated with the content to be displayed on the display and if the scale of the content is below a threshold continue using the first application to change the scale of the content displayed on the display.

In some embodiments there may also be provided a computer program comprising program instructions for causing a computer to perform the method described above.

In some embodiments there may also be provided a non-transitory entity embodying the computer program as described above.

In some embodiments there may also be provided an electromagnetic carrier signal carrying the computer program as described above.

According to various, but not necessarily all, embodiments of the disclosure there is provided a user interface comprising: a display configured to, use a first application to display content associated with a location; a user input device configured to enable a user to make a user input; wherein in response to the user input, determine the scale of the content and if the scale of the content is above a threshold access a second, different application to cause a graphical representation indicative of the location associated with the content to be displayed on the display and if the scale of the content is below a threshold continue using the first application to change the scale of the content displayed on the display.

In some embodiments the content may be associated with a location by assigning metadata to the content where the metadata enables the location to be uniquely identified.

The apparatus may be for wireless communication.

### BRIEF DESCRIPTION

For a better understanding of various examples of embodiments of the present disclosure reference will now be made by way of example only to the accompanying drawings in which:

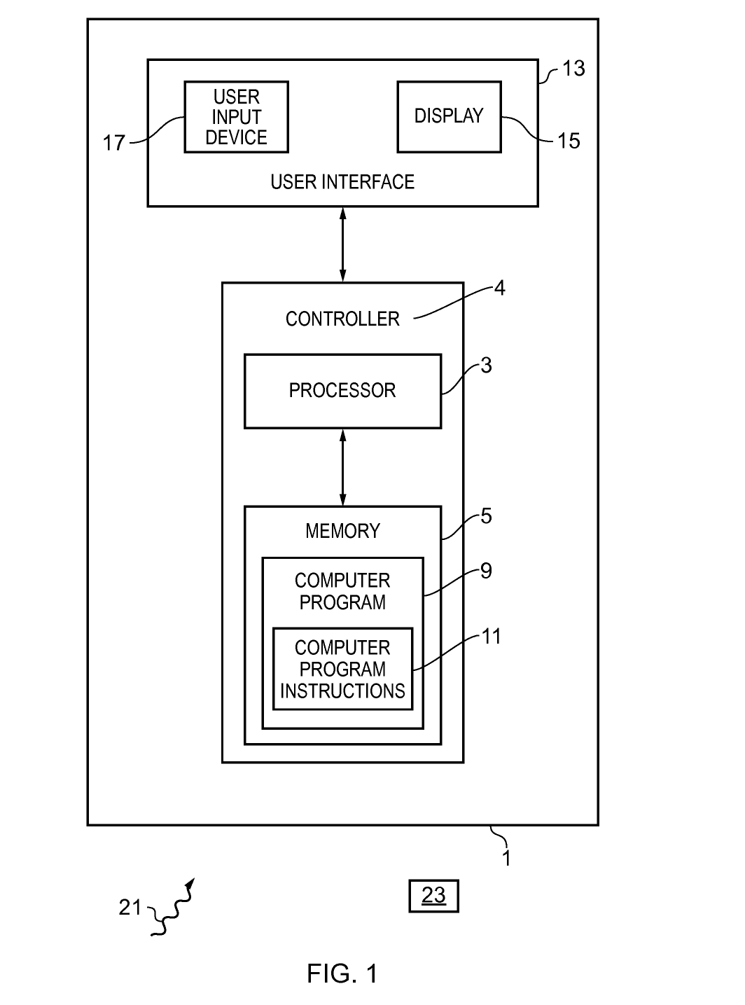

FIG. 1 schematically illustrates an apparatus according to an examplary embodiment of the disclosure;

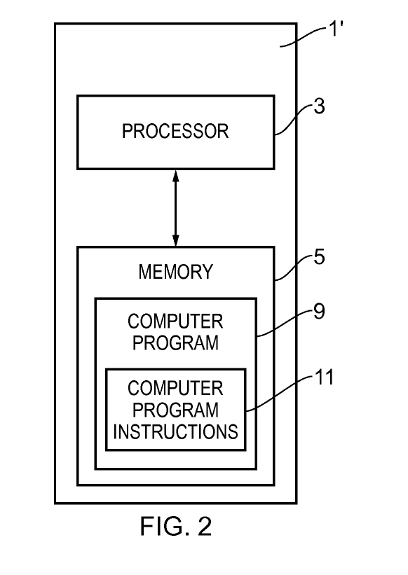

FIG. 2 schematically illustrates an apparatus according to another examplary embodiment of the disclosure;

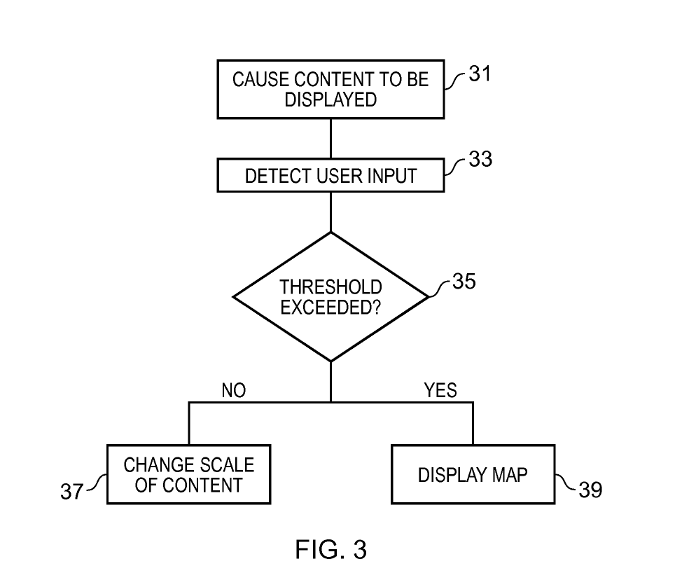

FIG. 3 is a block diagram which schematically illustrate methods according to an examplary embodiment of the disclosure;

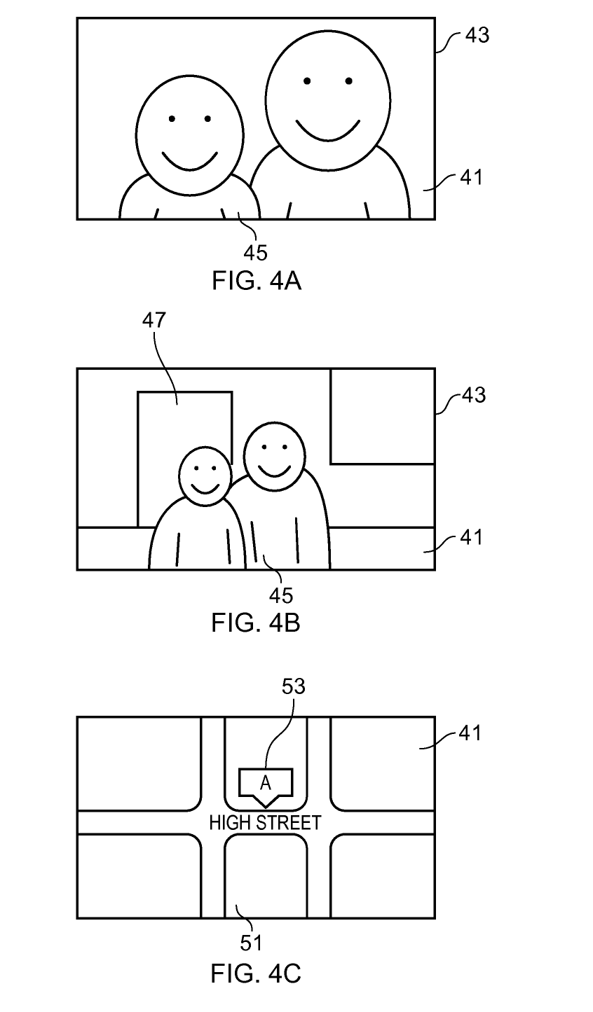

FIGS. 4A to 4C illustrate graphical user interfaces according to an examplary embodiment of the disclosure; and

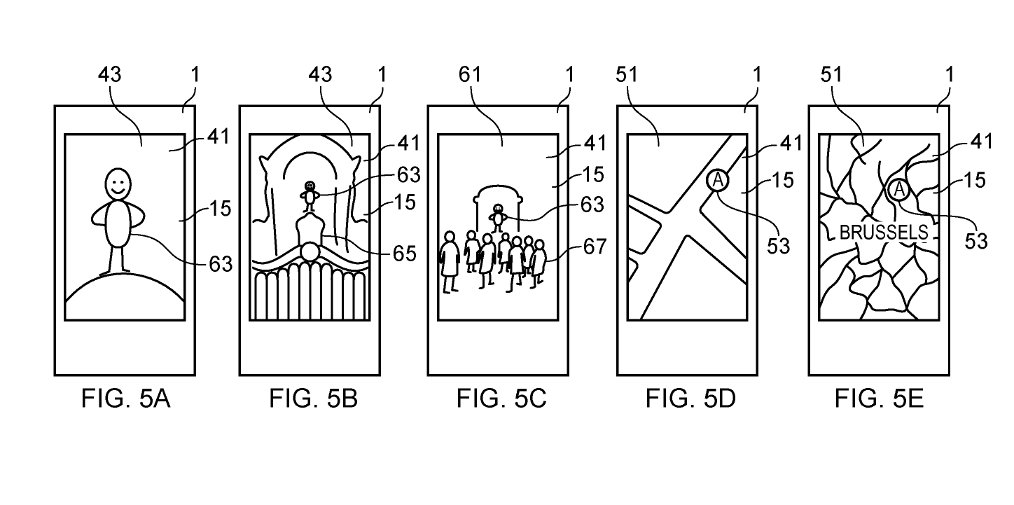

FIGS. 5A to 5D illustrate graphical user interfaces according to another examplary embodiment of the disclosure.

### DETAILED DESCRIPTION

The Figures illustrate a method comprising: using a first application to cause 31 content associated with a location to be displayed on a display 15; detecting a user input 33; and in response to the user input, determining 35 the scale of the content, and if the scale of the content is above a threshold accessing a second, different application to cause 39 a graphical representation indicative of the location associated with the content to be displayed on the display 15 and if the scale of the content is below a threshold continuing using the first application to change 37 the scale of the content displayed on the display 15.

FIG. 1 schematically illustrates an apparatus 1 according to an embodiment of the disclosure. The apparatus 1 may be an electronic apparatus. The apparatus 1 may be, for example, a mobile cellular telephone, a tablet computer, a personal computer, a camera, a gaming device, or any other apparatus which may enable a user to view content on a display 15. The apparatus 1 may be a handheld apparatus 1 which can be carried in a user's hand, handbag or pocket of their clothes for example.

Features referred to in the following description are illustrated in FIGS. 1 and 2. However, it should be understood that the apparatus 1 may comprise additional features that are not illustrated. For example, in embodiments of the disclosure where the apparatus 1 is configured for wireless communication the apparatus 1 may comprise one or more transmitters and receivers and in embodiments where the apparatus 1 is configured to enable a user to create photographs or videos the apparatus 1 may comprise one or more image capturing devices.

The apparatus 1 illustrated in FIG. 1 comprises: a user interface 13 and a controller 4. In the illustrated embodiment the controller 4 comprises at least one processor 3 and at least one memory 5 and the user interface 13 comprises a display 15 and a user input device 17.

The controller 4 provides means for controlling the apparatus 1. The controller 4 may be implemented using instructions that enable hardware functionality, for example, by using executable computer program instructions 11 in one or more general-purpose or special-purpose processors 3 that may be stored on a computer readable storage medium 23 (e.g. disk, memory etc.) to be executed by such processors 3.

The controller 4 may be configured to control the apparatus 1 to perform functions. A person skilled in the art would appreciate that the apparatus 1 may be used to perform any number and range of functions and applications. The functions may comprise, for example, viewing content 43 on a display 15. The content 43 may comprise any content such as images, videos or web pages. The content 43 which is displayed may have been created by the apparatus 1 for example, it may comprise an image which has been captured by the apparatus 1. In some embodiments the content 43 which is displayed may comprise content 43 which has been received by the apparatus 1. For example, the functions of the apparatus 1 may comprise communications functions such as, email services or messages such as SMS (short message service) messages, MMS (multimedia message service) which enable a user to send and receive content 43. Other functions which may be performed by the apparatus 1 may comprise map applications which may enable a user to view maps or access to services which use maps such as satellite navigation systems. The content 43 may be stored in the one or more memories 5 of the apparatus 1.

The controller 4 may also be configured to enable the apparatus 1 to perform a method comprising: using a first application to cause 31 content associated with a location to be displayed on a display 15; detecting a user input 33; and in response to the user input, determining 35 the scale of the content, and if the scale of the content is above a threshold accessing a second, different application to cause 39 a graphical representation indicative of the location associated with the content to be displayed on the display 15 and if the scale of the content is below a threshold continuing using the first application to change 37 the scale of the content displayed on the display 15.

The at least one processor 3 is configured to receive input commands from the user interface 13 and also to provide output commands to the user interface 13. The at least one processor 3 is also configured to write to and read from the at least one memory 5. Outputs of the user interface 13 may be provided as inputs to the controller 4.

The user input device 17 provides means for enabling a user of the apparatus 1 to input information which may be used to control the apparatus 1. The user input device 17 may comprise any means which enables a user to input information into the apparatus 1. For example the user input device 17 may comprise a touch sensitive display 15 or a portion of a touch sensitive display 15, one or more sensors configured to detect a bending, twisting or other deformation of a housing the apparatus 1, a key pad, an accelerometer or other means configured to detect orientation and/or movement of the apparatus 1, audio input means which enable an audio input signal to be detected and converted into a control signal for the controller 4, or a camera configured to detect movement of a user of the apparatus 1. It is to be appreciated that a combination of different types of user input devices 17 may be used.

In embodiments where the display 15 comprises a touch sensitive display 15 the touch sensitive display 15 may be actuated by a user contacting the surface of the touch sensitive display 15 with an object such as their finger or a stylus. A user may contact the surface of the touch sensitive display 15 by physically touching the surface of the touch sensitive display 15 with an object or by hovering or bringing the object close enough to the surface to activate the sensors of the touch sensitive display 15. The touch sensitive display 15 may comprise a capacitive touch sensitive display 15, or a resistive touch sensitive display 15 or any other suitable means for detecting a touch input.

The display 15 may comprise any means which enables information to be displayed to a user of the apparatus 1. The information which is displayed may comprise content 43 such as images or videos, or webpages, or codes such as a smart code or a QR (Quick Response) code.

A user may be able to use the user input device 17 to control the scale at which the content 43 is displayed on the display 15. A user may be able to increase the scale of the content 43 on the display 15, that is zoom in on the content 43 or decrease the scale of the content 43 on the display 15, that is zoom out on the content 43.

The display 15 may also be configured to display maps 51 or other graphical representations of real world locations. If a user makes a user input indicating that they wish to view a map the controller 4 may access a map or navigation application to retrieve the appropriate maps and cause them to be displayed on the display 15.

The display 15 may be configured to display graphical user interfaces 41 as illustrated in FIGS. 4A to 4C and 5A to 5E.

The at least one memory 5 is configured to store a computer program 9 comprising computer program instructions 11 that control the operation of the apparatus 1 when loaded into the at least one processor 3. The computer program instructions 11 provide the logic and routines that enable the apparatus 1 to perform the examplary methods illustrated in FIG. 3.

The at least one processor 3 by reading the at least one memory 5 is able to load and execute the computer program 9.

The computer program instructions 11 may provide computer readable program means configured to control the apparatus 1. The program instructions 11 may provide, when loaded into the controller 4; means for using a first application to cause 31 content associated with a location to be displayed on a display 15; means for detecting a user input 33; and means for in response to the user input, determining 35 the scale of the content, and if the scale of the content is above a threshold accessing a second, different application to cause 39 a graphical representation indicative of the location associated with the content to be displayed on the display 15 and if the scale of the content is below a threshold continuing using the first application to change 37 the scale of the content displayed on the display 15.

The computer program 9 may arrive at the apparatus 1 via any suitable delivery mechanism 21. The delivery mechanism 21 may comprise, for example, a computer-readable storage medium, a computer program product 23, a memory device, a record medium such as a CD-ROM or DVD, an article of manufacture that tangibly embodies the computer program 9. The delivery mechanism may be a signal configured to reliably transfer the computer program 9. The apparatus 1 may propagate or transmit the computer program 9 as a computer data signal.

The memory 5 may comprise a single component or it may be implemented as one or more separate components some or all of which may be integrated/removable and/or may provide permanent/semi-permanent/dynamic/cached storage.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (e.g. Von Neumann)/parallel architectures but also specialized circuits such as field-programmable gate arrays (FPGA), application specific integration circuits (ASIC), signal processing devices and other devices. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

FIG. 2 illustrates an apparatus 1′ according to another embodiment of the disclosure. The apparatus 1′ illustrated in FIG. 2 may be a chip or a chip-set. The apparatus 1′ comprises at least one processor 3 and at least one memory 5 as described above in relation to FIG. 1.

FIG. 3 illustrates a method according to examplary embodiments of the disclosure. At block 31 the controller 4 controls the display 15 to cause content 43 to be displayed.

A first application may be used to cause the display 15 to display the content. The first application may be, for example, a media application or a communications application or any other suitable application. The media application may be used to enable content stored in the one or more memories 5 to be retrieved from the one or more memories 5 and displayed on the display 15. A communications application may be used to enable the apparatus 1 to access networks such as the internet or cellular communications networks and access content which may be stored at a remote location.

The content 43 may comprise any information which is displayed on the display 15. In some examplary embodiments the content 43 may comprise an image. The image may be, for example, a photograph or other picture. In some embodiments of the disclosure the content 43 may comprise moving images such as videos. In other embodiments of the disclosure the content 43 may comprise a code such as a smart code or QR code.

In some embodiments the content 43 may comprise content 43 which has been created by the apparatus 1. For example the apparatus 1 may comprise an image capturing device which is configured to enable photographs or videos to be taken and stored in the one or more memories 5. The photographs or videos may then be displayed on the display 15.

In other embodiments of the disclosure the content 43 may comprise content 43 which has been received by the apparatus 1. The content 43 which is received may then be stored in the one or more memories 5. For example, the apparatus 1 may be configured to access a network such as the internet or a wireless communications network and enable content 43 such as web pages to be displayed on the display 15. In some embodiments the apparatus 1 may be configured to receive messages such as email messages or MMS messages which may comprise content 43 which can be displayed on the display 15.

In some embodiments the content 43 may comprise a code such as a smart code or QR code. In such embodiments the apparatus 1 may comprise a scanner or optical recognition device which is configured to detect the code.

In some embodiments of the disclosure the content 43 which is displayed on the display 15 at block 31 is associated with a location. For example, the content 43 may be geotagged. The location which is associated with the content 43 may comprise a real world location.

The content 43 may be associated with a location by assigning metadata to the content 43 where the metadata enables the location to be identified. The metadata may enable the location to be uniquely identified. The metadata may enable a representation of a real world location to be identified on a map 51 or other graphic representation of an area. The metadata may comprise any suitable data such as an address, post code, zip code, geographical coordinates or any other suitable information.

In some embodiments of the disclosure the content 43 may be associated with a location in response to a specific user input. For example a user may be able to use the user input device 17 to select an option which then enables the user to manually associate the content 43 displayed on the display 15 with a location.

In other embodiments of the disclosure the content 43 may be automatically associated with a location. For example, when the content 43 is created, the apparatus 1 which is used to create the content 43 may automatically access a locations application such as GPS (global positioning system) to determine the current location of the apparatus 1 and assign metadata indicative of that location to the content 43 which has just been created.

The content which is displayed at block 31 is displayed on the display 15 at a first scale. The scale of the content is the relative size of the content when it is displayed on the display 15.

At block 33 the controller 4 detects a user input. The user input may comprise any input which may be made by the user of the apparatus 1 and detected by the controller 4 to enable the controller 4 to provide a control output. The user input may be made by actuating the user input device 17.

In some embodiments of the disclosure the user input may comprise actuation of a touch sensitive display 15. The user may actuate the surface of the touch sensitive display 15 by making physical contact with the surface. In some embodiments the user may actuate the touch sensitive display 15 by hovering so that the object or finger is brought close to the surface of the touch sensitive display 15 but does not actually touch it. In some embodiments the user input may comprise a trace input which may be made by actuating the surface of the touch sensitive display 15 with a single finger or object and then dragging the single finger or object across the surface of the touch sensitive display 15.

In some embodiments of the disclosure the user input may comprise a multi-touch actuation of a touch sensitive display 15. For example a user may use two fingers to actuate two portions of the touch sensitive display 15 and then either move their fingers closer together or further apart. For example, a user may make a pinching motion with their fingers.

In other embodiments of the disclosure the user input may comprise a physical deformation of a housing of the apparatus 1. The housing may provide an external casing for the apparatus 1. The components of the apparatus 1, which are illustrated schematically in FIG. 1 and FIG. 2, may be contained within the housing. In such embodiments the housing of the apparatus 1 may comprise a flexible body portion which may be physically deformed by a user applying stress to the housing. The physical deformation may comprise bending, folding, twisting or stretching the housing of the apparatus 1 or a portion of the housing of the apparatus 1. In such embodiments the apparatus 1 may comprise one or more sensors which may be configured to detect contortions and other deformations of the apparatus 1 which are caused by a user applying stress to the housing of the apparatus 1. The sensors may be configured to detect different contortions and deformations and provide an output signal to the controller 4 which enables the controller 4 to determine between the different contortions and deformations. The sensors may also be configured to detect different magnitudes and directions of contortions and deformations.

In some embodiments of the disclosure the user input may comprise a movement of the user of the apparatus 1 which may be detected by an image capturing device such as a camera. The detection of the movement of the user of the apparatus 1 may be performed by a tracking module. The movement of the user of the apparatus 1 may be detected using any suitable process such as pattern recognition. For example, the finger of the user comprises patterns on the surface. The tracking module may be configured to detect these patterns and determine any change in the scale, orientation or location of the patterns. The user input may comprise movement of a part of the user such as a part of a user's hand 33, for example it may comprise movement of one or more of a users fingers and thumbs. The movement of the user of the apparatus 1 may comprise three dimensional motion, for example it could comprise motion of the user's finger in any three orthogonal directions. The motion may comprise moving the finger towards or away from the apparatus 1, moving the finger in a plane parallel with the back of the apparatus 1, rotating the finger or any combination of such movements. The movement of the user of the apparatus 1 may comprise a specific gesture. For example, the movement may be a predetermined movement or series of movements. For example it could be making a circling motion of a finger or thumb or moving a finger or thumb from side to side.

In some embodiments of the disclosure the user input may have a value associated with it. The value may comprise a magnitude. In some embodiments the value may also comprise a direction or other indication that the value may be positive or negative. The magnitude of the user input may comprise any quality of the user input which may vary in quantity. For example, the magnitude may comprise, the length of a trace input, the size of a deformation input, the length of time an input is made for or the number of times an input is made. The direction may comprise the direction that a trace input is made in, or whether a user draws two closer fingers together or further apart or the direction the housing is deformed in.

It is to be appreciated that the user inputs described above are examplary and that other user inputs could be used in other embodiments of the disclosure.

At block 35 the controller 4 determines whether or not a threshold has been exceeded. If the threshold has not been exceeded then, at block 37 the controller 4 controls the display 15 to change the scale of the content 43 displayed on the display 15. If the threshold has been exceeded then, at block 37 the controller 4 controls the display 15 to display a graphical representation indicative of the location associated with the content.

The threshold may be the scale of the content 43. The scale may be the scale of the content 43 as it is currently displayed on the display 15. In some embodiments the scale may be the scale at which the content would be displayed after the user input, if the user input only caused a change in scale of content.

In some embodiments the threshold may be a value of the user input. For example, the threshold may be the magnitude of an input such as a trace input or a distortion input. In some embodiments the threshold may be whether the value of user input is positive or negative.

At block 37, the threshold has not been exceeded and the scale of content 43 displayed on the display 15 is changed. The controller 4 may continue using the first application to cause the change in scale of the content 43. The amount by which the scale of the content 43 is changed may be proportionate to a value of the user input. For example, the larger the value of the user input, the larger the change in scale of the content 43.

The scale of the content 43 may be increased so that it causes a zoom out of the content 43 if the user input is determined to have a first direction or a positive value. The scale of the content 43 may be decreased so that it causes a zoom in of the content 43 if the user input is determined to have a second direction or negative value.

If the threshold is exceeded then, at block 39, the controller 4 controls the display 15 to display a graphical representation of the location associated with the content 43. The controller 4 may access a second, different application and use the second, different application to cause a graphical representation indicative of the location associated with the content to be displayed on the display.

The graphical representation of the location may comprise any image which enables a user to determine the location associated with the content 43. For example the graphical representation may comprise a map 51. The map 51 may be a political map 51 which may indicate infrastructure such as streets, roads towns and cities. In other embodiments the map 51 may comprise a physical map which may indicate geographical features and natural features such as the relief of the land. In other embodiments of the disclosure the graphical representation may comprise photographic images of the location. The photographic images may be a panoramic view such as street view or a satellite image.

In order to display the graphical representation of the location the controller 4 may determine that there is a location associated with the content 43 and may obtain information indicative of that location. For example, the controller 4 may determine that there is metadata associated with the content 43 displayed on the display 15 and may analyse the metadata to determine that the metadata comprises data which is indicative of a location and retrieve the data which is indicative of the location.

The second, different application which is accessed by the controller 4 may comprise a map or navigation application which enables graphical representations of locations to be displayed on the display 15. Once the controller 4 has obtained the data indicative of the location associated with the content 43 the controller 4 may use the map or navigation application to retrieve a map which comprises the location associated with the content 43 displayed on the display 15. The controller 4 then causes this map to be displayed on the display 15.

The blocks illustrated in the FIG. 3 may represent steps in a method and/or sections of code in the computer program 9. The illustration of a particular order to the blocks does not necessarily imply that there is a required or preferred order for the blocks and the order and arrangement of the block may be varied. Furthermore, it may be possible for some blocks to be omitted.

FIGS. 4A to 4C illustrate graphical user interfaces 41 according to an examplary embodiment of the disclosure. The graphical user interfaces 41 may be displayed on the display 15.

In FIG. 4A the controller 4 controls the display 15 to display content 43 at a first scale. In this particular embodiment the content 43 comprises a picture of two people 45. The picture may be a photograph which may have been created by the apparatus 1 or which may have been received by the apparatus 1 or which is accessible to a user of the apparatus 1 over a communications network such as the internet or a cellular communications network. The controller 4 may use a first application to cause the content 43 to be displayed on the display 15.

In FIG. 4A the scale of the content 43 is such that only a part of the content can be displayed on the display 15 simultaneously. In the examplary embodiment in FIG. 4 only the faces of the two people 45 in the picture can be viewed on the display 15 simultaneously. It is to be appreciated that the user may be able to use the user input device 17 to make user inputs which enable the user to scroll through the image so that different portions of the content 43 are displayed on the display 15.

In the embodiments of the disclosure the content 43 has a location associated with it. The location may be, for example, the place where the content 43 was created. For example, where the content 43 comprises a photograph the location associated with the content 43 may be the location that the photograph was taken.

In other embodiments the location which is associated with the content 43 may be a different location. For example, the content 43 may comprise a smart code or QR code which may contain information relating to a business or event. In such embodiments the location associated with the content 43 may be the location of the business or the event which need not necessarily be the place where the code was originally created.

In FIG. 4B the user has made a first user input. The user input may have been any suitable user input such as actuation of a touch sensitive display 15, bending or twisting of a housing of the apparatus 1 or a movement of the user of the apparatus 1 which may have been detected by a camera or any other suitable user input.

In FIG. 4B the controller 4 has determined 35 that the threshold has not been exceeded and controls the display 15 to change the scale of the content 43 displayed on the display 15. For example, the controller 4 may determine that the scale of the content 43 is not at a threshold level because only a portion of the image is displayed on the display 15.

In FIG. 4B the scale of the content 43 has decreased so that more of the picture is displayed on the display 15 simultaneously. In the examplary embodiment in FIG. 4B the head and torso of the two people 45 can be viewed simultaneously as well as some of the buildings 47 in the background of the picture.

In FIG. 4C the user has made a second user input And the controller 4 has determined 35 that the threshold has been exceeded and controls the display 15 to display a graphical representation indicative of the location associated with the content 43.

The controller 4 may determine that the threshold of the scale of the content 43 has been exceeded because all of the image 43 is displayed on the display 15 simultaneously or because the scale or resolution of the content 43 is above a maximum level.

The graphical representation of the location may comprise any image which enables a user to determine the location associated with the content 43. In the particular embodiment in FIG. 4C the graphical representation comprises a map 51. In other embodiments of the disclosure the graphical representation may comprise photographic images for example, a panoramic view such as street view, or a satellite image.

In FIG. 4C the location associated with the content 43 is indicated on the map 51 by the label 53. In some embodiments of the disclosure other labels may also be indicated on the map 51. The other labels may comprise an indication of other locations of interest such as the current location of the user, other locations which the user has viewed on the map 51 or visited with their apparatus 1 or any other locations.

FIGS. 5A to 5E illustrate graphical user interfaces 41 according to another examplary embodiment of the disclosure. The graphical user interfaces 41 may also be displayed on the display 15 of an apparatus 1.

In FIG. 5A the controller 4 uses a first application to control the display 15 to display content 43 at a first scale. In the examplary embodiment the content 43 comprises a photograph which has been taken using the apparatus 1. The content 43 is displayed at a first scale such that only a portion of the photograph can be displayed on the display 15 simultaneously.

In the examplary embodiment on FIG. 5A the photograph is of a statue 63. In FIG. 5A the scale of the content 43 is such that only the statue is displayed on the display 15.

In FIG. 5B the user has made a user input. The controller 4 has determined that a threshold has not been exceeded and so has caused a change of the scale of the content 43 displayed on the display 15. For example, the controller 4 has determined that the scale of the content 43 is not above a predetermined threshold. The controller 4 may continue using the first application to cause the change in scale of the content 43.

In FIG. 5B the same content 43 is displayed at a reduced scale so that the user input has caused zooming out of the content 43. The statue 63 is displayed on the display 15 at a smaller scale so that the statue 63 and also the plinth 65 and other surroundings which are contained within the photograph are displayed simultaneously.

In FIG. 5C the user has made a further user input. In response to the further user input the controller 4 has determined that a first threshold has been exceeded but that a second threshold has not been exceeded. For example, the scale of the content which is displayed on the display in FIG. 5B may be above a first threshold but below a second threshold. The user may be able to view all of the image on the display but if the user were to continue zooming out it may be considered too small for the user to view.

In this particular embodiment the further user input causes the controller 4 to access and retrieve further content 61 associated with the same location as the original content 43. The controller 4 may continue using the same application to retrieve the further content 61. In some embodiments the controller 4 may use a second different application to retrieve the further content 61.

It is to be appreciated that any suitable method may be used to find further content 61 associated with the same location. For example, in order to find and retrieve the further content 61 the controller 4 may determine that there is metadata associated with the content 43 originally displayed on the display 15. The metadata may provide an indication of the location associated with the original content 43. In some embodiments, where the original content 43 comprises an image, the metadata may comprise information relating to objects within the image. The controller 4 may be configured to use the metadata to find further content 61 having corresponding metadata associated with it.

The further content 61 may be stored in a remote server. The apparatus 1 may use a communication network, such as the internet or a wireless communications network, to access the remote server and retrieve the further content 61. Once the further content 61 has been retrieved the controller 4 causes the retrieved content to be displayed on the display 15.

In the examplary embodiment in FIG. 5C the further content 61 comprises another photograph of the same statue 63 which has been captured by a different user on another day. In this photograph a crowd of people 67 in front of the statue 63 is contained within the photograph.

In FIG. 5D the user has made another user input. The controller 4 has determined that both the first threshold and the second threshold have been exceeded. For example the controller 4 may determine that the further content 61 is displayed at its minimum scale so that to zoom out any further would make the content 43 too small for the user to view.

The controller 4 accesses a maps or other appropriate application to retrieve a map 51 indicating the location associated with the content 43, 61. The controller 4 then causes the retrieved map 51 to be displayed on the display 15. The location associated with the content 43, 61 is indicated on the map 51 by the label 53.

In FIG. 5E the user has again made a further user input. As the map 51 is already displayed on the display 15, in this examplary embodiment, the further input causes the change of the scale of the map 51.

In FIG. 5E the controller 4 has zoomed out of the map so that the scale of the map in FIG. 5E is smaller than the scale of the map displayed in FIG. 5D. The change in scale of the map 51 may be proportionate to the value of the user input which has been detected. The location associated with the content 43, 61 is still indicated on the map 51 by the label 53.

Embodiments of the disclosure provide the advantage that they enable a user to easily determine a location associated with content. For example a user may be viewing content such as photographs and by making a simple user input the controller may automatically access a map or navigation application which enables them to determine the location at which the photograph was created. This provides for a smooth transition between different applications which makes the apparatus easier and more convenient for a user to use.

Similarly, in some embodiments, the user may have obtained a code such as a smart code or QR code. In such embodiments the controller may automatically access a map or navigation application which enables the user to determine a location associated with the code. This could be the location of a business or event associated with the code. This may enable a user to easily determine the locations associated with codes without having to manually access a navigation or maps application which may make the apparatus easier and more convenient for the user to use.

In embodiments of the disclosure a similar user input may be made to change the scale of the content on the display and also cause the maps to be displayed. This may make the apparatus simple to use as there are less different types of user input for the user to use. It may also make the apparatus more intuitive for a user to use as the input which enables a user to zoom out may also be used to cause the map to be displayed which may cognitively be associated with the process of zooming out.

Although embodiments of the present disclosure have been described in the preceding paragraphs with reference to various examples, it should be appreciated that modifications to the examples given can be made without departing from the scope of the disclosure as claimed. For example in the embodiments of the disclosure described above, the map or other graphical representation replaces the content on the display so that the content and the map are not displayed simultaneously.

In other embodiments of the disclosure the display may be divided into portions so that the content may be displayed in one portion and the graphical representation of the location may be displayed in another, different portion.

In some embodiments the content may displayed overlaying the graphical representation of the location. The content may be displayed overlaying the portion of the graphical representation of the location corresponding to the location associated with the content. For example, if the content comprises a photograph taken at a particular location and the graphical representation of the location comprises a panoramic view such as street view then the photograph may be displayed overlaying the portion of the panoramic view in which the particular location is represented. This may enable the content to be displayed in context within graphical representations of location. In some embodiments the content may be rescaled and/or cropped so as to fit in the graphical representation of the location. This may cause only part of the original content to remain on the display when the graphical representation of the location is displayed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the disclosure believed to be of particular importance it should be understood that the Applicant claims protection in respect of any patentable feature or combination of features hereinbefore referred to and/or shown in the drawings whether or not particular emphasis has been placed thereon.

I/we claim:

1. A method comprising:
using a first application to cause content associated with a location to be displayed on a display;
detecting a user input; and
in response to the user input, determining the scale of the content, and if the scale of the content is above a threshold accessing a second, different application to cause a graphical representation indicative of the location associated with the content to be displayed on the display and if the scale of the content is below a threshold continuing using the first application to change the scale of the content displayed on the display.

2. The method of claim 1 wherein the content is associated with a location by assigning metadata to the content where the metadata enables the location to be uniquely identified.

3. The method of claim 1 wherein the location comprises a real world location.

4. The method of claim 1 wherein the content is geotagged.

5. The method of claim 1 wherein the content comprises at least one of an image, a video.

6. (canceled)

7. The method of claim 1 wherein the graphical representation of the location comprises a map.

8. The method of claim 1 wherein the graphical representation of the location replaces the content on the display.

9. The method of claim 1 wherein the graphical representation of the location is displayed with the content overlaying the portion of the graphical representation of the location corresponding to the location associated with the content

10. The method of claim 1 further comprising, in response to the user input, determining a value of the user input and if the value of the user input is above a threshold accessing the second, different application and if the value of the user input is below a threshold continuing using the first application to change the scale of the content displayed on the display by an amount determined by the value of the user input.

11. The method of claim 10 wherein the user input comprises deforming a housing of an apparatus and the value of the user input comprises the magnitude and direction of the deformation.

12. The method of claim 10 wherein the user input comprises actuating a touch sensitive display by making a trace input and the value of the user input comprises the length and direction of the trace.

13. An apparatus comprising:
at least one processor; and
at least one memory including computer program code;
wherein the at least one memory and the computer program code are configured to, with the at least one processor, enable the apparatus to:
use a first application to cause content associated with a location to be displayed on a display;
detect a user input; and
in response to the user input, determine the scale of the content and if the scale of the content is above a threshold access a second, different application to cause a graphical representation indicative of the location associated with the content to be displayed on the display and if the scale of the content is below a threshold continue using the first application to change the scale of the content displayed on the display.

14. The apparatus of claim 13 wherein the content is associated with a location by assigning metadata to the content where the metadata enables the location to be uniquely identified.

15. The apparatus of claim 13 wherein the location comprises a real world location.

16. The apparatus of claim 13 wherein the content is geotagged.

17. The apparatus of claim 13 wherein the content comprises at least one of an image, a video.

18. (canceled)

19. The apparatus of claim 13 wherein the graphical representation of the location comprises a map.

20. The apparatus of claim 13 wherein at least one memory and the computer program code are configured to, with the at least one processor, enable the apparatus to replace the content on the display with the graphical representation of the location.

21. The apparatus of claim 13 wherein at least one memory and the computer program code are configured to, with the at least one processor, enable the apparatus to display the graphical representation of the location with the content overlaying the portion of the graphical representation of the location corresponding to the location associated with the content.

22-24. (canceled)

25. A non-transitory computer readable medium comprising computer program instructions that, when executed by at least one processor, enable an apparatus at least to perform:
use a first application to cause content associated with a location to be displayed on a display;
detect a user input; and
in response to the user input, determine the scale of the content and if the scale of the content is above a threshold access a second, different application to cause a graphical representation indicative of the location associated with the content to be displayed on the display and if the scale of the content is below a threshold continue using the first application to change the scale of the content displayed on the display.

26-30. (canceled)
